(19) United States
(12) Patent Application Publication
(10) Pub. No.: US 2025/0320385 A1
(43) Pub. Date: Oct. 16, 2025

(54) PRESSURE-SENSITIVE ADHESIVE COMPOSITION, PRESSURE-SENSITIVE ADHESIVE SHEET, LAMINATE, AND METHOD FOR PRODUCING ß-1,3-GLUCAN DERIVATIVE

(71) Applicant: NITTO DENKO CORPORATION, Ibaraki-shi, Osaka (JP)

(72) Inventors: Tatsuya KUMADA, Osaka (JP); Kazuyuki KIUCHI, Osaka (JP); Mao NOCHI, Osaka (JP)

(73) Assignee: NITTO DENKO CORPORATION, Ibaraki-shi, Osaka (JP)

(21) Appl. No.: 18/871,867

(22) PCT Filed: Jun. 14, 2023
(86) PCT No.: PCT/JP2023/022169

§ 371 Date: Dec. 5, 2024

(30) Foreign Application Priority Data
Jun. 22, 2022 (JP) 2022-100709

(51) Int. Cl. C09J 7/38; C08B 37/00; G01N 25/20

(52) U.S. Cl. CPC C09J 7/38; C08B 37/0024; C09J 2301/302; C09J 2405/00; G01N 25/20

(57) ABSTRACT

The present invention provides a pressure-sensitive adhesive composition suitable for producing a pressure-sensitive adhesive sheet having a low glass transition temperature. The pressure-sensitive adhesive composition according to the present invention includes a β-1,3-glucan derivative G. The β-1,3-glucan derivative G has an acyl group a having a carbon number of 8 or more and an acyl group b having a carbon number different from the carbon number of the acyl group a, and the carbon number of the acyl group b is 8 or more. A pressure-sensitive adhesive sheet 1 according to the present invention is formed from the pressure-sensitive adhesive composition. A laminate 10 according to the present invention includes the pressure-sensitive adhesive sheet 1 and a substrate sheet 2.

### TECHNICAL FIELD

The present invention relates to a pressure-sensitive adhesive composition, a pressure-sensitive adhesive sheet, a laminate, and a method for producing a β-1,3-glucan derivative.

### BACKGROUND ART

In recent years, bioplastics in which renewable resources are utilized have been examined from the viewpoint of reducing environmental load. As the renewable resource, for example, polysaccharides derived from organisms and plants are known. Specific examples of such polysaccharides include β-glucan containing β-glucose (specifically, β-D-glucose) as a constituent sugar.

The β-glucan is classified into a β-1,4-glucan, a β-1,3-glucan or the like depending on bonding positions of the β-glucoses. Specific examples of the β-1,4-glucan include cellulose, and specific examples of the β-1,3-glucan include paramylon. The paramylon is synthesized, for example, by photosynthesis of microalgae such as Euglena. The microalgae can be easily cultured, and furthermore, the microalgae can advantageously absorb a large amount of carbon dioxide during the culturing process.

From the viewpoint of effectively utilizing β-1,3-glucan such as paramylon, it has been considered to introduce a substituent into β-1,3-glucan and synthesize a β-1,3-glucan derivative. For example, Patent Literature 1 discloses that a β-1,3-glucan derivative with an acyl group introduced is used for applications such as an adhesive.

### CITATION LIST

### Patent Literature

Patent Literature 1: JP 6890316 B

### SUMMARY OF INVENTION

### Technical Problem

In the case of preparing a pressure-sensitive adhesive composition by using the β-1,3-glucan derivative disclosed in Patent Literature 1, the pressure-sensitive adhesive sheet formed from the pressure-sensitive adhesive composition is unlikely to exhibit sufficient pressure-sensitive adhesiveness in a low-temperature environment of about 0° C. or lower. The investigations by the present inventors indicate that there is a need of adjusting the glass transition temperature of the pressure-sensitive adhesive sheet in order to provide a pressure-sensitive adhesive sheet capable of exhibiting sufficient pressure-sensitive adhesiveness in a low-temperature environment.

Therefore, the present invention aims to provide a pressure-sensitive adhesive composition suitable for producing a pressure-sensitive adhesive sheet having a low glass transition temperature.

### Solution to Problem

The present invention provides a pressure-sensitive adhesive composition including a β-1,3-glucan derivative, wherein
the β-1,3-glucan derivative includes an acyl group a having a carbon number of 8 or more, and an acyl group b having a carbon number different from the carbon number of the acyl group a, and the carbon number of the acyl group b is 8 or more.

The present invention further provides a pressure-sensitive adhesive sheet formed from the above-described pressure-sensitive adhesive composition.

The present invention further provides a laminate including:
the above-described pressure-sensitive adhesive sheet, and a substrate sheet.

The present invention further provides a method for producing a β-1,3-glucan derivative, the method including:
introducing an acyl group a having a carbon number of 8 or more into β-1,3-glucan dissolved in a solvent A to synthesize an intermediate product with the acyl group a introduced, and
introducing an acyl group b into the intermediate product dissolved in a solvent B different from the solvent A to synthesize the β-1,3-glucan derivative, where the acyl group b has a carbon number different from the carbon number of the acyl group a, and the carbon number of the acyl group b is 8 or more.

### Advantageous Effects of Invention

According to the present invention, it is possible to provide a pressure-sensitive adhesive composition suitable for producing a pressure-sensitive adhesive sheet having a low glass transition temperature.

### BRIEF DESCRIPTION OF DRAWINGS

FIG. 1 is a cross-sectional view schematically showing a pressure-sensitive adhesive sheet according to one embodiment of the present invention.

FIG. 2 is a drawing illustrating a method for measuring a peeling strength of the pressure-sensitive adhesive sheet.

FIG. 3 is a cross-sectional view schematically showing a laminate according to one embodiment of the present invention.

FIG. 4 is a cross-sectional view schematically showing a laminate according to a modification.

FIG. 5 is a graph showing results of differential scanning calorimetry carried out on β-1,3-glucan derivatives synthesized in Examples and Comparative Examples.

### DESCRIPTION OF EMBODIMENTS

A pressure-sensitive adhesive composition according to a first aspect of the present invention includes a β-1,3-glucan derivative, wherein
the β-1,3-glucan derivative includes an acyl group a having a carbon number of 8 or more and an acyl group b having a carbon number different from the carbon number of the acyl group a, and the carbon number of the acyl group b is 8 or more.

According to a second aspect of the present invention, for example, in the pressure-sensitive adhesive composition according to the first aspect, the acyl group a is represented by the following formula (1):

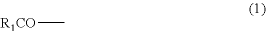

where R₁ is a hydrocarbon group having a carbon number of 10 to 15.

According to a third aspect of the present invention, for example, in the pressure-sensitive adhesive composition according to the second aspect, the R₁ is an alkyl group having a carbon number of 10 to 15.

According to a fourth aspect of the present invention, for example, in the pressure-sensitive adhesive composition according to any one of the first to the third aspects, the acyl group b is represented by the following formula (2):

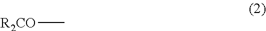

where R₂ is a hydrocarbon group having a carbon number of 7 to 9.

According to a fifth aspect of the present invention, for example, in the pressure-sensitive adhesive composition according to the fourth aspect, the R₂ is an alkyl group having a carbon number of 7 to 9.

According to a sixth aspect of the present invention, for example, in the pressure-sensitive adhesive composition according to any one of the first to the fifth aspects, a total value of a degree of substitution of the acyl group a and a degree of substitution of the acyl group b in the β-1,3-glucan derivative is 2.6 or more and less than 3.0.

According to a seventh aspect of the present invention, for example, in the pressure-sensitive adhesive composition according to any one of the first to the sixth aspects, a ratio (Mₐ:M_{b}) of an amount of substance Mₐ of the acyl group a to an amount of substance M_{b} of the acyl group b in the β-1,3-glucan derivative is in a range of 1:2 to 2:1.

According to an eighth aspect of the present invention, for example, in the pressure-sensitive adhesive composition according to any one of the first to the seventh aspects, the β-1,3-glucan derivative has a glass transition temperature of 15.0° C. or lower.

According to a ninth aspect of the present invention, for example, in the pressure-sensitive adhesive composition according to the first aspect, no endothermic peak is present in a DSC curve created by the following test:
the β-1,3-glucan derivative is placed in a differential scanning calorimeter, and the β-1,3-glucan derivative is heated from 25° C. to 250° C. at a temperature rise rate of 15° C./min. in a nitrogen atmosphere;
the β-1,3-glucan derivative is cooled from 250° C. to −80° C. at a temperature drop rate of 5° C./min.;
the β-1,3-glucan derivative is heated a second time from −80° C. to 250° C. at a temperature rise rate of 5° C./min.; and
a DSC curve is created from data obtained during the second time heating.

A pressure-sensitive adhesive sheet according to a tenth aspect of the present invention is formed from the pressure-sensitive adhesive composition according to any one of the first to the ninth aspects.

A laminate according to an eleventh aspect of the present invention includes:
the pressure-sensitive adhesive sheet according to the tenth aspect, and a substrate sheet.

A method according to a twelfth aspect of the present invention is a method for producing a β-1,3-glucan derivative, the method including:
introducing an acyl group a having a carbon number of 8 or more into β-1,3-glucan dissolved in a solvent A to synthesize an intermediate product with the acyl group a introduced, and
introducing an acyl group b into the intermediate product dissolved in a solvent B different from the solvent A to synthesize the β-1,3-glucan derivative, where the acyl group b has a carbon number different from the carbon number of the acyl group a and the carbon number of the acyl group b is 8 or more.

According to a thirteenth aspect of the present invention, for example, in the method according to the twelfth aspect, the solvent A includes dimethylacetamide.

According to a fourteenth aspect of the present invention, for example, in the method according to the twelfth or the thirteenth aspect, the solvent B includes at least one selected from the group consisting of toluene, cyclohexane, and tetrahydrofuran.

The present invention will be described below in detail. However, the following description is not intended to limit the present invention to a specific embodiment.

### (Embodiment of Pressure-Sensitive Adhesive Composition)

A pressure-sensitive adhesive composition of this embodiment includes a β-1,3-glucan derivative G. The β-1,3-glucan derivative G has an acyl group a and an acyl group b. The acyl group a has a carbon number of 8 or more. The acyl group b has a carbon number different from the carbon number of the acyl group a, and the carbon number of the acyl group b is 8 or more. In other words, the β-1,3-glucan derivative G has at least two kinds of acyl groups.

### [β-1,3-Glucan Derivative]

The β-1,3-glucan derivative G functions, for example, as a base polymer in a pressure-sensitive adhesive composition. The β-1,3-glucan derivative G has a glucose unit U connected to a β-1,3-glucoside bond. The β-1,3-glucan derivative G includes the glucose unit U as a main component, and, preferably, the β-1,3-glucan derivative G is substantially formed merely of the glucose unit U. In the present description, the “main component” means a constituent unit that is included at the largest amount on a weight basis among all the constituent units of the β-1,3-glucan derivative G. The “substantially formed merely of” means that other components that may modify the intrinsic feature of the constituent unit described above are excluded, and this means, for example, constituted by 95 wt % or more and more preferably 99 wt % or more of the constituent unit. However, the β-1,3-glucan derivative G may further include a constituent unit other than the glucose unit U.

Examples of the glucose unit U include a glucose unit U1, which is not connected to any glucoside bond other than the β-1,3-glucoside bond, and a glucose unit U2, which is connected to another glucoside bond as well as the β-1,3-glucoside bond. Examples of the other glycosidic bond connected to glucose unit U2 include, for example, a β-1,6-glucoside bond.

In the β-1,3-glucan derivative G, usually the number of glucoside bonds connected to one glucose unit U is 1 to 3. The β-1,3-glucan derivative G including the glucose unit U connected to three glucoside bonds can be considered to have a branched structure. Meanwhile, the β-1,3-glucan derivative G formed merely of the glucose unit U connected to one glucoside bond and the glucose unit U connected to two glucoside bonds can be considered to have no branched structure and have a linear structure.

The glucose unit U has, for example, a structure in which the acyl groups a and b are introduced into hydroxy groups included in an unsubstituted glucose unit. In an example, the glucose unit U has an ester group formed by introducing the acyl group a or b into a hydroxy group.

As described above, the carbon number of the acyl group a is 8 or more. The carbon number of the acyl group a is preferably 11 or more, 12 or more, and furthermore, may be 13 or more. The carbon number of the acyl group a is, for example, 19 or less, 18 or less, 17 or less, 16 or less, 15 or less, and furthermore may be 14 or less. The carbon number of the acyl group a is preferably 11 to 16.

The acyl group a is, for example, represented by the following formula (1).

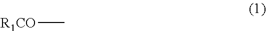

In formula (1), R₁ represents a hydrocarbon group. The hydrocarbon group may have a substituent, but preferably has no substituents. In R₁, the carbon number of the hydrocarbon group is, for example, 7 or more, 10 or more, 11 or more, and furthermore, may be 12 or more. The carbon number of the hydrocarbon group is, for example, 18 or less, 17 or less, 16 or less, 15 or less, 14 or less, and furthermore, may be 13 or less. The carbon number of the hydrocarbon group is preferably 10 to 15.

As for R₁, examples of the hydrocarbon group include aliphatic hydrocarbon groups, alicyclic hydrocarbon groups, and aromatic hydrocarbon groups, and aliphatic hydrocarbon groups are preferable. The aliphatic hydrocarbon group may be branched, but is preferably linear. Examples of the aliphatic hydrocarbon group include saturated aliphatic hydrocarbon groups and unsaturated aliphatic hydrocarbon groups, and saturated aliphatic hydrocarbon groups (alkyl groups) are preferable. Examples of the unsaturated aliphatic hydrocarbon group include an alkenyl group.

R₁ is preferably an alkyl group having a carbon number of 10 to 15. Examples of the alkyl group having a carbon number of 10 to 15 include a decyl group, an undecyl group, a dodecyl group, a tridecyl group, a tetradecyl group, and a pentadecyl group.

Specific examples of the acyl group a represented by Formula (1) include a lauroyl group, a myristoyl group, and a palmitoyl group. Among them, the myristoyl group is preferred. However, the acyl group a is not limited to these specific examples as long as the carbon number of the acyl group a is different from the carbon number of the acyl group b, and the carbon number of the acyl group a is 8 or more.

As described above, the carbon number of the acyl group b is 8 or more. The carbon number of the acyl group b is preferably 10 or less, or may be 9 or less. The carbon number of the acyl group b is preferably 8 to 10.

The acyl group b is represented, for example, by the following formula (2).

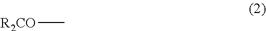

In Formula (2), R₂ is a hydrocarbon group. The hydrocarbon group may have a substituent, but preferably does not have a substituent. In R₂, the hydrocarbon group has a carbon number of 7 or more, for example. The carbon number of the hydrocarbon group is, for example, 9 or less, and may be 8 or less. The carbon number of the hydrocarbon group is preferably 7 to 9.

As for the R₂, examples of the hydrocarbon group include aliphatic hydrocarbon groups, alicyclic hydrocarbon groups, and aromatic hydrocarbon groups, and aliphatic hydrocarbon groups are preferable. The aliphatic hydrocarbon group may be branched, but is preferably linear. Examples of the aliphatic hydrocarbon group include saturated aliphatic hydrocarbon groups and unsaturated aliphatic hydrocarbon groups, and saturated aliphatic hydrocarbon groups (alkyl groups) are preferable. Examples of the unsaturated aliphatic hydrocarbon group include an alkenyl group.

The R₂ is preferably an alkyl group having a carbon number of 7 to 9. Examples of the alkyl group having a carbon number of 7 to 9 include a heptyl group, an octyl group, and a nonyl group.

Specific examples of the acyl group b represented by formula (2) include an octanoyl group, a nonanoyl group, and a decanoyl group, and the octanoyl group is preferred. However, the acyl group b is not limited to these specific examples as long as it has a carbon number different from the carbon number of the acyl group a, and the carbon number of the acyl group b is 8 or more.

In the β-1,3-glucan derivative G, a total value T of a degree of substitution (DS value) of the acyl group a and a degree of substitution (DS value) of the acyl group b is, for example, more than 2.5, 2.6 or more, 2.7 or more, 2.8 or more, and furthermore, may be 2.9 or more. In a case where the total value T is great to such a degree, interaction between molecular chains becomes weak in the β-1,3-glucan derivative G, and a pressure-sensitive adhesive strength of the pressure-sensitive adhesive composition tends to be increased. The total value T is, for example, less than 3.0, and in some cases, it may be 2.9 or less, or 2.8 or less. In this case, at the time of forming the pressure-sensitive adhesive sheet from the pressure-sensitive adhesive composition, hydroxy groups remaining in the β-1,3-glucan derivative G can react with a crosslinking agent described below. The total value T is preferably 2.6 or more and less than 3.0.

The above-described total value T specifically represents the number of acyl groups (acyl groups a and b) in one glucose unit included in the β-1,3-glucan derivative G. In a case where the total value T is 3, the β-1,3-glucan derivative G is considered to have a structure in which acyl groups are introduced into almost all of hydroxy groups included in an unsubstituted glucose unit. The total value T can be determined by nuclear magnetic resonance spectroscopy (1H-NMR) for the β-1,3-glucan derivative G. Specifically, an NMR spectrum is obtained by 1H-NMR for the β-1,3-glucan derivative G. From the obtained NMR spectrum, peaks derived from hydrogen atoms that are bonded directly to 1-position to 6-position carbon atoms in the glucose unit of the β-1,3-glucan derivative G, and a peak derived from an acyl group are determined. The total value T can be determined based on integral values of these peaks.

In the β-1,3-glucan derivative G, the DS value of the acyl group a is not particularly limited, and is, for example, 1.0 to 2.0. Similarly, the DS value of the acyl group b is not particularly limited, and is, for example, 1.0 to 2.0.

In the β-1,3-glucan derivative G, a ratio (Mₐ:M_{b}) of the amount of substance Mₐ of the acyl group a to the amount of substance M_{b} of acyl group b is not particularly limited and is, for example, 1:2 to 2:1. The ratio (Mₐ:M_{b}) corresponds to the ratio of the DS value of the acyl group a to the DS value of the acyl group b. The ratio (Mₐ:M_{b}) can be calculated from the compositions of the acyl groups a and b, the above-described total value T, and the integral value of the peaks derived from the acyl groups (acyl groups a and b) in the NMR spectrum of the β-1,3-glucan derivative G.

The β-1,3-glucan derivative G is preferably a paramylon derivative. A paramylon derivative is represented, for example, by the following formula (3).

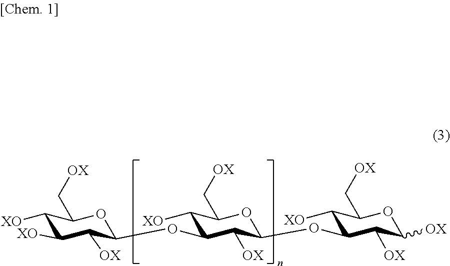

In formula (3), n is an integer. Xs each independently represent a hydrogen atom, an acyl group a, or an acyl group b. At least one of a plurality of Xs is an acyl group a. Similarly, at least one of a plurality of Xs is an acyl group b.

The β-1,3-glucan derivative G is not limited to a paramylon derivative. Other examples of the β-1,3-glucan derivative G include a cardran derivative, a laminaran derivative, a schizophyllan derivative, a pachyman derivative, and a lentinin derivative.

The weight-average molecular weight of the β-1,3-glucan derivative G is not particularly limited, and is, for example, 10000 or more, 30000 or more, 100000 or more, 200000 or more, 300000 or more, and furthermore, may be 400000 or more. The weight-average molecular weight of the β-1,3-glucan derivative G is, for example, 1000000 or less, 800000 or less, and furthermore, may be 500000 or less.

The β-1,3-glucan derivative G tends to have a low glass transition temperature (Tg) due to the presence of the acyl groups a and b. The glass transition temperature of the β-1,3-glucan derivative G is, for example, 15.0° C. or lower, 14.0° C. or lower, 13.0° C. or lower, 12.0° C. or lower, 11.0° C. or lower, and furthermore, may be 10.0° C. or lower. The lower limit of the glass transition temperature of the β-1,3-glucan derivative G is not particularly limited, and is, for example, −10.0° C.

The glass transition temperature of the β-1,3-glucan derivative G can be determined by the following method. Firstly, a disc-shaped evaluation sample is produced from the β-1,3-glucan derivative G. The evaluation sample has, for example, a bottom surface diameter of 7.9 mm and a thickness of approximately 0.7 mm. The evaluation sample can be prepared, for example, by the following method. Firstly, a sheet formed of the β-1,3-glucan derivative G is produced. This sheet may be a pressure-sensitive adhesive sheet formed from a pressure-sensitive adhesive composition formed of the β-1,3-glucan derivative G and a solvent. The pressure-sensitive adhesive sheets can be produced by the method described below. Subsequently, the pressure-sensitive adhesive sheets are laminated, and the resulting laminate is punched out into a disc shape. In this way, the evaluation sample can be prepared.

Subsequently, the evaluation sample is sandwiched between parallel plates and set in a dynamic viscoelasticity measurement device. As the dynamic viscoelasticity measurement device, for example, ARES-G2 manufactured by TA Instruments can be used. The dynamic viscoelasticity measurement is carried out under the following conditions using the dynamic viscoelasticity measurement device.

### (Measurement Conditions)

Frequency: 1 Hz
Deformation mode: Torsion
Measurement temperature: −60° C. to 200° C.
Temperature rise rate: 5° C./min

Subsequently, based on the results of the dynamic viscoelasticity measurement, a graph showing the relation between temperature and tanδ (loss tangent) is created. The tanδ corresponds to a ratio G″/G′ of a loss modulus G″ to a storage modulus G′. From the graph thus created, the peak top of tanδ can be determined, and the temperature corresponding to the peak top can be regarded as the glass transition temperature of the β-1,3-glucan derivative G.

Furthermore, the β-1,3-glucan derivative G tends to have low crystallinity due to the presence of the acyl groups a and b. In this embodiment, for example, there is no endothermic peak in the DSC curve produced by the following Test 1.

Test 1: The β-1,3-glucan derivative is placed in a differential scanning calorimeter and heated from 25° C. to 250° C. at a temperature rise rate of 15° C./min. in a nitrogen atmosphere. Subsequently, the β-1,3-glucan derivative is cooled from 250° C. to −80° C. at a temperature drop rate of 5° C./min. Subsequently, the β-1,3-glucan derivative is heated a second time from −80° C. to 250° C. at a temperature rise rate of 5° C./min. A DSC curve is created from the data obtained during the second time heating.

The absence of an endothermic peak in the DSC curve indicates that the β-1,3-glucan derivative G does not crystallize during the cooling process in Test 1 described above. As can be seen from the results of Comparative Example 2 described below, in the case where the Test 1 is carried out on a β-1,3-glucan derivative that has a single acyl group with a large number of carbons, an endothermic peak tends to appear in the DSC curve. In other words, the β-1,3-glucan derivative having a single acyl group with a large number of carbons tends to have high crystallinity due to the presence of the acyl group.

The presence or absence of an endothermic peak in the DSC curve can be determined by the following method, for example. Firstly, an acyl group having a larger number of carbons, which is selected from the acyl group a and the acyl group b (typically, the acyl group a) is introduced into the β-1,3-glucan so as to synthesize a β-1,3-glucan derivative for testing. The β-1,3-glucan derivative for testing has a structure in which the acyl group b of the β-1,3-glucan derivative G is replaced by the acyl group a. The β-1,3-glucan derivative for testing can be synthesized by the same method for producing the β-1,3-glucan derivative G described below.

Subsequently, the aforementioned Test 1 is carried out on the β-1,3-glucan derivative for testing to create a DSC curve from the data obtained during the second time heating. Usually, presence of an endothermic peak can be read from this DSC curve. A temperature S corresponding to the peak top of this endothermic peak is determined. For example, in the case of using a paramylon derivative that includes a lauroyl group (C12) alone as the acyl group, the temperature S is approximately −40° C. In the case of using a paramylon derivative that includes a myristoyl group (C14) alone as the acyl group, the temperature S is approximately −15° C. In the case of using a paramylon derivative that includes a palmitoyl group (C16) alone as an acyl group, the temperature S is approximately 10° C. In the DSC curve, the heat flow usually shows a minimum value at the peak top of the endothermic peak.

Subsequently, a heat absorption in the range of the above-mentioned temperature S±30° C. is calculated from the DSC curve of the β-1,3-glucan derivative G. When the calculated heat absorption is in a range of −5 J/g to 5 J/g, it can be regarded that there is no endothermic peak in the DSC curve.

In the pressure-sensitive adhesive composition, a content of the β-1,3-glucan derivative G is not particularly limited, and is, for example, 1 wt % or more, 10 wt % or more, 30 wt % or more, 50 wt % or more, 80 wt % or more, and furthermore, may be 90 wt % or more. The pressure-sensitive adhesive composition may be substantially formed merely of the β-1,3-glucan derivative G.

A method for producing the β-1,3-glucan derivative G, includes, for example:
introducing an acyl group a into β-1,3-glucan dissolved in a solvent A to synthesize an intermediate product with the acyl group a introduced (first step); and
introducing an acyl group b into the intermediate product dissolved in a solvent B different from the solvent A to synthesize the β-1,3-glucan derivative G (second step).

Specifically, the first step can be carried out by the following method. Firstly, the β-1,3-glucan is dissolved in a solvent A to prepare a first solution. The β-1,3-glucan has the same structure as the β-1,3-glucan derivative G, except that the β-1,3-glucan is formed merely of unsubstituted glucose units. The solvent A preferably includes a high polarity organic solvent. Examples of high polarity organic solvents include dimethylacetamide (DMAc), dimethyl sulfoxide (DMSO), formic acid, and dimethylformamide. The solvent A preferably includes DMAc as a high polarity organic solvent. When preparing the first solution, a salt such as LiCl may be further added to improve the solubility of the β-1,3-glucan in the solvent A. Further, the solvent A may be heated to sufficiently dissolve the β-1,3-glucan in the solvent A.

Subsequently, a first reactant for introducing the acyl group a into the β-1,3-glucan is added to the first solution described above. The first reactant is typically an acylating agent. Examples of the acylating agent include an acid chloride and an acid anhydride. In addition, if necessary, a basic compound may be added to the first solution to promote the reaction between the β-1,3-glucan and the first reactant. Examples of the basic compounds include amine compounds such as pyridine and triethylamine.

Subsequently, by causing the hydroxyl group in the β-1,3-glucan to react with the first reactant, an acyl group a is introduced into the β-1,3-glucan. The conditions for the reaction between the β-1,3-glucan and the first reactant can be set appropriately according to the kinds of the β-1,3-glucan and the first reactant.

The above-mentioned intermediate product can be synthesized by the reaction between the β-1,3-glucan and the first reactant. In the intermediate product, the DS value of the acyl group a is not particularly limited, and it is, for example, 1.0 to 2.0. In the intermediate product, some of the hydroxyl groups contained in the β-1,3-glucan remain.

Subsequently, a solid intermediate product is obtained by precipitating the intermediate product from the first solution or by removing the solvent A from the first solution. The intermediate product may be purified as necessary.

Specifically, the second step can be carried out in the following manner. Firstly, a second solution is prepared by dissolving the intermediate product in a solvent B that is different from the solvent A. The solvent B is preferably an organic solvent (low polarity organic solvent) with lower polarity than the solvent A. The solvent B includes preferably as a low polarity organic solvent at least one selected from the group consisting of toluene, cyclohexane, and tetrahydrofuran, and more preferably, the solvent B includes toluene. The second solution may be free of salts such as LiCl.

Subsequently, a second reactant for introducing an acyl group b into the intermediate product is added to the second solution. Similarly to the first reactant, the second reactant may be an acylating agent such as an acid chloride or an acid anhydride. Furthermore, if necessary, a basic compound may be added to the second solution to promote the reaction between the intermediate product and the second reactant. The second solution may be prepared by dissolving the intermediate product in a mixed solution including the basic compound and the solvent B. The basic compound may be any of those described above.

Subsequently, the acyl group b is introduced into the intermediate product by causing the hydroxyl group included in the intermediate product to react with the second reactant. The conditions for the reaction between the intermediate product and the second reactant can be set appropriately according to the kinds of the intermediate product and the second reactant.

The β-1,3-glucan derivative G can be synthesized by a reaction between the intermediate product and the second reactant. A solid β-1,3-glucan derivative G can be obtained by precipitating the β-1,3-glucan derivative G from the second solution or by removing the solvent B from the second solution. The β-1,3-glucan derivative G may be purified as necessary.

Patent Literature 1 discloses that a paramylon derivative is synthesized by introducing an acyl group into paramylon in a state where the paramylon is not dissolved in a solvent (heterogeneous system). According to investigations by the inventors of the present invention, in a case where the paramylon derivative is synthesized by the method, unwanted gels tend to be formed. It is presumed that these gels are formed by a condensation of the paramylon derivatives with each other due to the hydroxyl groups remaining in the paramylon derivatives.

In contrast, in the producing method of this embodiment, an introduction reaction of the substituent is carried out in a state where the β-1,3-glucan and the intermediate product are dissolved in a solvent (homogeneous system) in both the first step and the second step. According to this method, the above-mentioned condensation reaction is inhibited, whereby formation of unwanted gels can be inhibited. By using the β-1,3-glucan derivative G produced by this producing method, it is possible to prepare a pressure-sensitive adhesive composition including less amount of the unwanted gels. In a case where a pressure-sensitive adhesive sheet is produced from such a pressure-sensitive adhesive composition, there is a tendency that occurrence of unevenness on the surface of the pressure-sensitive adhesive sheet is inhibited.

### [Additives]

The pressure-sensitive adhesive composition may further include an additive in addition to the β-1,3-glucan derivative G. Examples of the additive include another base polymer, a tackifier, a crosslinking agent, a photoradical generator, a radically polymerizable compound, a solvent, a viscosity adjusting agent, a leveling agent, a plasticizer, a filler, a stabilizer, a preservative, and an anti-aging agent. The pressure-sensitive adhesive composition may further include an additive, such as a tackifier, and may further include a crosslinking agent.

Examples of the other base polymer include a (meth)acrylic resin.

The tackifier is a component for enhancing a pressure-sensitive adhesive strength of the pressure-sensitive adhesive composition. The tackifier includes, for example, at least one selected from the group consisting of a terpene-based resin, a rosin-based resin, and a petroleum-based resin.

Examples of the terpene-based resin include terpene resins, hydrides of terpene resins, aromatic modified terpene resins, phenol-modified terpene resins, and hydrides of phenol-modified terpene resins, and the terpene resin and the aromatic modified terpene resin are preferable. Examples of the terpene resin include α-pinene polymers, β-pinene polymers, and dipentene polymers.

Examples of the rosin-based resin include disproportionated rosin, rosin ester, phenol-modified rosin, hydrogenated rosin, polymerized rosin, maleated rosin, fumarated rosin, and disproportionated maleic acid-modified rosin resin, and rosin ester and phenol-modified rosin are preferable. Examples of the rosin ester include pentaerythritol ester-modified rosin resin.

Examples of the petroleum-based resin include aliphatic (C5) petroleum resins, aromatic (C9) petroleum resins, aliphatic/aromatic copolymerization (C5/C9) petroleum resins, hydrogenated products thereof, modified products thereof (for example, maleic anhydride modified product), coumarone resins, coumarone-indene resins, and styrene-based tackifiers, and a hydrogenated product, in particular, a hydrogenated product of an aromatic (C9) petroleum resin is preferable.

A blending amount of the tackifier is not particularly limited. In an example, a blending amount of the tackifier with respect to 100 parts by weight of the β-1,3-glucan derivative G is, for example, 5 parts by weight or more, 10 parts by weight or more, and furthermore, may be 20 parts by weight or more. A blending amount of the tackifier with respect to 100 parts by weight of the β-1,3-glucan derivative G is, for example, 150 parts by weight or less, 100 parts by weight or less, 80 parts by weight or less, 60 parts by weight or less, and furthermore, may be 40 parts by weight or less.

The crosslinking agent is preferably a crosslinking agent that can react with hydroxy groups remaining in the β-1,3-glucan derivative G. Examples of the crosslinking agent include isocyanate-based crosslinking agents, oxazoline-based crosslinking agents, carbodiimide-based crosslinking agents, and epoxy crosslinking agents. The crosslinking agent may include a compound C containing (meth)acryloyl groups and hydroxy group-reactive functional groups. The crosslinking agent preferably includes an isocyanate-based crosslinking agent.

Examples of the isocyanate-based crosslinking agent include adduct-type isocyanate-based crosslinking agents, isocyanurate-type isocyanate-based crosslinking agents, and allophanate-type isocyanate-based crosslinking agents. Furthermore, examples of the isocyanate-based crosslinking agent include hexamethylene diisocyanate (HDI)-type crosslinking agents, tolylene diisocyanate (TDI)-type crosslinking agents, xylylene diisocyanate (XDI)-type crosslinking agents, and hydrogenated xylylene diisocyanate (H6XDI) (also known as 1,3-bis(isocyanatomethyl)cyclohexane)-type crosslinking agents.

Examples of the HDI-type crosslinking agent include a trimethylolpropane adduct of HDI, isocyanurate of HDI, and allophanate of HDI, and isocyanurate of HDI is preferable. In a case where isocyanurate of HDI is used, a component of the pressure-sensitive adhesive composition tends to be inhibited from remaining in an adherend. Examples of the TDI-type crosslinking agent include a trimethylolpropane adduct of TDI, isocyanurate of TDI, and allophanate of TDI. Examples of the XDI-type crosslinking agent include a trimethylolpropane adduct of XDI, isocyanurate of XDI, and allophanate of XDI. Examples of the H6XDI-type crosslinking agent include H6XDI, a trimethylolpropane adduct of H6XDI, isocyanurate of H6XDI, and allophanate of H6XDI.

In the compound C containing (meth)acryloyl groups and hydroxy group-reactive functional groups, the (meth)acryloyl group represents acryloyl group and/or methacryloyl group. Examples of the hydroxy group-reactive functional group include an isocyanate group, an epoxy group, an alkoxysilyl group, an acid anhydride group, and an acid chloride group, and an isocyanate group is preferable. The number of the (meth)acryloyl groups included in the compound C may be one, or two or more. The number of the hydroxy group-reactive functional groups included in the compound C may be one, or two or more.

The compound C can react with hydroxy groups remaining in the β-1,3-glucan derivative G via the hydroxy group-reactive functional group. By causing the compound C to react with the β-1,3-glucan derivative G, the (meth)acryloyl groups can be introduced into the β-1,3-glucan derivative G. By causing a plurality of the β-1,3-glucan derivatives G to react with each other by using the (meth)acryloyl groups, the β-1,3-glucan derivatives G can be crosslinked. In the description herein, a reaction product of the β-1,3-glucan derivative G and the compound C may also be simply referred to as the β-1,3-glucan derivative G.

Examples of the compound C including isocyanate groups as the hydroxy group-reactive functional groups include isocyanatoalkyl (meth)acrylate and (meth)acryloyl(poly)oxyalkylene alkyl isocyanate. Specific examples of the isocyanatoalkyl (meth)acrylate include isocyanatomethyl (meth)acrylate, isocyanatoethyl (meth)acrylate, isocyanatopropyl (meth)acrylate, and isocyanatobutyl (meth)acrylate. Examples of the (meth)acryloyl(poly)oxyalkylene alkyl isocyanate include (meth)acryloylpolyoxyethylene ethyl isocyanate and (meth)acryloyloxyethyloxyethyl isocyanate.

As the compound C including isocyanate groups, a commercially available compound can be used. Examples of the commercially available compound include Karenz AOI (2-isocyanatoethyl acrylate manufactured by Showa Denko K.K.), Karenz MOI (2-isocyanatoethyl methacrylate manufactured by Showa Denko K.K.), and Karenz MOI-EG (2-(2-methacryloyloxyethyloxy)ethyl isocyanate manufactured by Showa Denko K.K.).

A blending amount of the crosslinking agent is not particularly limited. In an example, a blending amount of the crosslinking agent with respect to 100 parts by weight of the β-1,3-glucan derivative G is, for example, 0.01 parts by weight or more, 0.1 parts by weight or more, 0.5 parts by weight or more, 1.0 part by weight or more, 3.0 parts by weight or more, and furthermore, may be 5.0 parts by weight or more. A blending amount of the crosslinking agent with respect to 100 parts by weight of the β-1,3-glucan derivative G is, for example, 50 parts by weight or less, 25 parts by weight or less, 20 parts by weight or less, 15 parts by weight or less, and furthermore, may be 10 parts by weight or less. A blending amount of the crosslinking agent with respect to 100 parts by weight of the β-1,3-glucan derivative G may be 5.0 parts by weight or less or 3.0 parts by weight or less depending on the cases.

In a case where the pressure-sensitive adhesive composition includes the above-described compound C as the crosslinking agent, it is preferable that the pressure-sensitive adhesive composition further includes a photoradical generator, and the pressure-sensitive adhesive composition may further include a radically polymerizable compound. The photoradical generator is a compound that generates radicals when irradiated with light. In the description herein, examples of the light include radiation (gamma rays, X-rays, etc.), ultraviolet rays, and visible light.

Examples of the photoradical generator include a benzyl ketal-based compound, an α-hydroxy ketone-based photopolymerization initiator, an α-amino ketone-based photopolymerization initiator, an acyl phosphine oxide-based photopolymerization initiator, an oxime ester-based photopolymerization initiator, an acridine-based photopolymerization initiator, a titanocene-based photopolymerization initiator, a benzophenone-based photopolymerization initiator, an acetophenone-based photopolymerization initiator, an aromatic ketoester-based photopolymerization initiator, and a benzoic acid ester-based photopolymerization initiator. A benzyl ketal-based compound is preferable. As the photoradical generator, a commercially available photoradical generator can be used. Examples of the commercially available photoradical generator include Omnirad 184, 369, 500, 651, 819, 907, 784, and 2959 (all of which are manufactured by IGM Resins B.V.), and CGI-1700, -1750, -1850, CG 24-61, and Darocur 1116, 1173 (all of which are manufactured by BASF).

A blending amount of the photoradical generator is not particularly limited. In an example, a blending amount of the photoradical generator with respect to 100 parts by weight of the β-1,3-glucan derivative G is, for example, 0.01 parts by weight or more, 0.05 parts by weight or more, 0.075 parts by weight or more, and furthermore, may be 0.1 parts by weight or more. A blending amount of the photoradical generator with respect to 100 parts by weight of the β-1,3-glucan derivative G is, for example, 5 parts by weight or less, 1 part by weight or less, 0.5 parts by weight or less, and furthermore, may be 0.2 parts by weight or less.

The radically polymerizable compound is, for example, a radically polymerizable unsaturated compound having a double bond, and examples thereof include (meth)acryls, (meth)acrylamides, aromatic vinyls, vinyl esters, and acrylonitriles. The (meth)acryl represents acryl and/or methacryl.

Examples of (meth)acryl include (meth)acrylic monomers and (meth)acrylic oligomers. In the (meth)acrylic monomer, a residue bonded to a (meth)acryloyl group includes no repeating units. The (meth)acrylic monomer may include a functional group or include no functional group. Examples of the (meth)acrylic monomer include (meth)acrylic acid alkyl ester, carboxyl group-containing (meth)acrylic monomers, and hydroxy group-containing (meth)acrylic monomers.

Examples of the (meth)acrylic acid alkyl ester include (meth)acrylic acid alkyl ester having a linear or branched aliphatic alkyl group or an alicyclic alkyl group. Specific examples of the (meth)acrylic acid alkyl ester include methyl (meth)acrylate, ethyl (meth)acrylate, butyl (meth)acrylate, 2-ethylhexyl (meth)acrylate, nonyl (meth)acrylate, lauryl (meth)acrylate, cyclohexyl (meth)acrylate, and isobornyl (meth)acrylate.

Examples of the carboxyl group-containing (meth)acrylic monomer include (meth)acrylic acid. Examples of the hydroxy group-containing (meth)acrylic monomer include 2-hydroxyethyl (meth)acrylate, 3-hydroxypropyl (meth)acrylate, and 4-hydroxybutyl (meth)acrylate.

In the (meth)acrylic oligomer, a residue bonded to a (meth)acryloyl group includes repeating units. The (meth)acrylic oligomer may include a functional group or include no functional group. Examples of the (meth)acrylic oligomer include alkoxy polyoxyalkylene glycol mono(meth)acrylate, carboxyl group-containing (meth)acrylic oligomers, and hydroxy group-containing (meth)acrylic oligomers.

Examples of alkoxy polyoxyalkylene glycol mono(meth)acrylate include alkoxy polyoxyethylene glycol mono(meth)acrylate, in particular, methoxypolyoxyethylene glycol mono (meth)acrylate.

Examples of the carboxyl group-containing (meth)acrylic oligomer include ω-carboxy-polycaprolactone mono (meth)acrylate. Examples of the hydroxy group-containing (meth)acrylic oligomer include polyoxyalkylene glycol mono(meth)acrylate.

As the (meth)acrylic oligomer, a commercially available (meth)acrylic oligomer can be used. Examples of the commercially available (meth)acrylic oligomer include BLEMMER AME400 (methoxypolyethylene glycol-acrylate manufactured by NOF CORPORATION) and ARONIX M-5300 (ω-carboxy-polycaprolactone (n (degree of polymerization)≈2) monoacrylate manufactured by TOAGOSEI CO., LTD.).

A blending amount of the radically polymerizable compound is not particularly limited. In an example, a blending amount of the radically polymerizable compound with respect to 100 parts by weight of the β-1,3-glucan derivative G is, for example, 0.001 parts by weight or more, 0.01 parts by weight or more, 0.1 parts by weight or more, 1 part by weight or more, and furthermore, may be 3 parts by weight or more. A blending amount of the radically polymerizable compound with respect to 100 parts by weight of the β-1,3-glucan derivative G is, for example, 100 parts by weight or less, 10 parts by weight or less, and furthermore, may be 7 parts by weight or less.

The solvent may be typically an organic solvent or water. The organic solvent may be a low polarity solvent or a high polarity solvent. Examples of the low polarity organic solvent include aromatic compounds, alicyclic compounds, and saturated linear hydrocarbon compounds. Examples of the aromatic compound include toluene. Examples of the alicyclic compound include cyclohexane and methylcyclohexane. Examples of the saturated linear hydrocarbon compound include pentane, hexane, and heptane.

Examples of the high polarity organic solvent include ketone, ester, and alcohol. Examples of the ketone include methyl ethyl ketone. Examples of the ester include ethyl acetate. Examples of the alcohol include methanol and ethanol.

In a case where the pressure-sensitive adhesive composition includes a solvent, a solid content concentration of the pressure-sensitive adhesive composition is, for example, 1 wt % or more, or may be 10 wt % or more. The solid content concentration of the pressure-sensitive adhesive composition may be 50 wt % or less, or 40 wt % or less.

### (Embodiment of Pressure-Sensitive Adhesive Sheet)

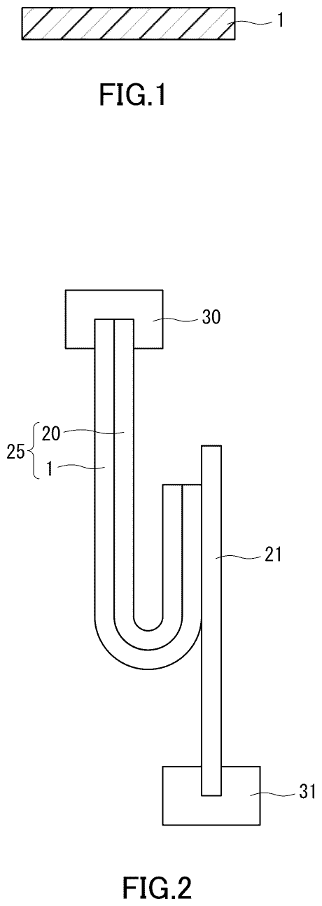

FIG. 1 shows an example of a pressure-sensitive adhesive sheet 1 according to the present embodiment. The pressure-sensitive adhesive sheet 1 is formed from the above-described pressure-sensitive adhesive composition. In the pressure-sensitive adhesive sheet 1, occurrence of unevenness on the surface is inhibited. In other words, the pressure-sensitive adhesive sheet 1 may have a smooth surface. The thickness of the pressure-sensitive adhesive sheet 1 is not particularly limited, and is, for example, 1 μm to 1000 μm.

The pressure-sensitive adhesive sheet 1 can be, for example, produced by the following method. Firstly, the pressure-sensitive adhesive composition is applied to a substrate sheet to obtain a coating film. As the substrate sheet, a substrate sheet described below for a laminate can be used. Subsequently, the coating film is dried, and the pressure-sensitive adhesive sheet 1 can thus be obtained. The coating film can be, for example, dried by heating the coating film. The temperature for heating the coating film is not particularly limited, and is, for example, 30° C. or higher, and may be 100° C. or higher. A time for heating the coating film is not particularly limited, and is, for example, 5 minutes or more, or may be 30 minutes or more. In a case where the pressure-sensitive adhesive composition includes the photoradical generator, the coating film may be irradiated with light when or after the coating film is dried.

The pressure-sensitive adhesive sheet 1 of this embodiment tends to have a low glass transition temperature Tg due to the β-1,3-glucan derivative G. The glass transition temperature of the pressure-sensitive adhesive sheet 1 is, for example, 15.0° C. or lower, and may be 14.0° C. or lower, 13.0° C. or lower, 12.0° C. or lower, 11.0° C. or lower, or even 10.0° C. or lower. The lower limit of the glass transition temperature of the pressure-sensitive adhesive sheet 1 is not particularly limited, and is, for example, −10.0° C. The glass transition temperature of the pressure-sensitive adhesive sheet 1 can be measured in the same manner as the glass transition temperature of the β-1,3-glucan derivative G, except that the pressure-sensitive adhesive sheet 1 is used instead of the sheet formed of the β-1,3-glucan derivative G.

In the case where the glass transition temperature of the pressure-sensitive adhesive sheet 1 is low, the pressure-sensitive adhesive sheet 1 tends to exhibit sufficient pressure-sensitive adhesiveness even in low-temperature environments. In other words, the pressure-sensitive adhesive sheet 1 tends to have pressure-sensitive adhesive properties that are less likely to change depending on the use environments. The pressure-sensitive adhesive sheet 1 is suitable for use in environments where temperature changes occur, such as outdoors, and in low-temperature environments in winter.

The pressure-sensitive adhesive sheet 1 preferably has an appropriate peeling strength. In an example, a peeling strength F of the pressure-sensitive adhesive sheet 1 as measured in the test described below is, for example, 0.1 N/20 mm or more, 0.3 N/20 mm or more, 0.5 N/20 mm or more, 0.7 N/20 mm or more, and furthermore, may be 0.8 N/20 mm or more. The upper limit value of the peeling strength F of the pressure-sensitive adhesive sheet 1 is not particularly limited, and is, for example, 20 N/20 mm.

The peeling strength F of the pressure-sensitive adhesive sheet 1 can be measured by the following method (FIG. 2). Firstly, a laminate formed of the pressure-sensitive adhesive sheet 1 and a substrate sheet 20 is produced. As the substrate sheet 20, for example, Lumirror S-10 (polyester film, thickness of 25 μm) manufactured by Toray Industries, Inc. is used. In the laminate, the thickness of the pressure-sensitive adhesive sheet 1 is adjusted to be, for example, 50 μm. Subsequently, the laminate is cut so as to have a width of 20 mm and a length of 70 mm, whereby a test piece 25 is produced.

Subsequently, in an environment of 23° C. and 50% RH, the test piece 25 and a stainless steel test plate 21 are stacked through the pressure-sensitive adhesive sheet 1, and press-bonded by reciprocating once a 2 kg roller. As the stainless steel test plate 21, for example, an SUS304BA plate is used. In this state, the obtained product is left as it is for 30 minutes, and is thereafter set at a tensile tester as shown in FIG. 2. Specifically, one end of the stainless steel test plate 21 is fixed to a lower chuck 31 of the tensile tester, and an end portion of the test piece 25 on the lower chuck 31 side is folded back by 180°, and fixed to an upper chuck 30 of the tensile tester. Subsequently, the test piece 25 is peeled off from the stainless steel test plate 21 at a peeling speed of 300 mm/min and a peeling angle of 180°. The average value of the peeling strengths obtained at this time is specified as the peeling strength F of the pressure-sensitive adhesive sheet 1.

### (Embodiment of Laminate)

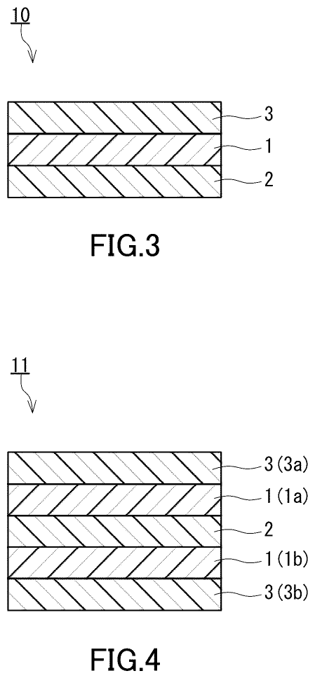

FIG. 3 shows an example of a laminate according to the present embodiment. A laminate 10 shown in FIG. 3 includes the pressure-sensitive adhesive sheet 1 and a substrate sheet 2, and may further include a release liner 3. In the laminate 10, the pressure-sensitive adhesive sheet 1 is, for example, disposed between the substrate sheet 2 and the release liner 3, and is in direct contact with each of the substrate sheet 2 and the release liner 3. The laminate 10 is typically a pressure-sensitive adhesive tape. The laminate 10 can be used by peeling the release liner 3.

The substrate sheet 2 is, for example, a sheet including resin such as polyester. The substrate sheet 2 may function as a release liner since it is subjected to a release treatment on its surface being in contact with the pressure-sensitive adhesive sheet 1. The thickness of the substrate sheet 2 is not particularly limited, and is, for example, 0.5 μm to 900 μm.

The release liner 3 is, for example, a sheet that is subjected to a release treatment on its surface being in contact with the pressure-sensitive adhesive sheet 1. Examples of materials of the release liner 3 include resins such as polyester. The thickness of the release liner 3 is not particularly limited, and is, for example, 0.5 μm to 900 μm.

FIG. 4 shows a laminate according to a modification of the present embodiment. A laminate 11 shown in FIG. 4 includes two pressure-sensitive adhesive sheets 1 and two release liners 3. Except for this, the laminate 11 has the same structure as the laminate 10 shown in FIG. 3.

Specifically, the laminate 11 has a laminate structure in which a release liner 3a, a pressure-sensitive adhesive sheet 1a, the substrate sheet 2, a pressure-sensitive adhesive sheet 1b, and a release liner 3b are laminated in this order. The laminate 11 is typically a double-sided pressure-sensitive adhesive tape. The laminate 11 can be used by peeling the release liners 3a and 3b.

The above-described laminates 10 and 11 can be, for example, distributed and stored as a wound body obtained by winding a band-shaped laminate, or a sheet-shaped laminate.

### EXAMPLES

The present invention will be described below in more detail by way of Examples and Comparative Examples. However, the present invention is not limited to these examples.

### Example 1

### [First Step]

Firstly, 5.19 g of paramylon (amount of substance of glucose unit: 32.0 mmol) was prepared as the β-1,3-glucan, which was then dried at a reduced pressure of 200 Pa and at 60° C. for 1 hour. Further, 4.07 g of LiCl (3 equivalents (96.0 mmol) to a glucose unit of paramylon) was prepared and dried at 130° C. for 1 hour. Subsequently, the paramylon and the LiCl were placed in a 3 L flask, to which nitrogen was supplied at a flow rate of 0.5 L/min. for 10 minutes to create a dry nitrogen atmosphere inside the flask. Subsequently, 500 mL of dehydrated DMAc was introduced as a solvent A, which was stirred at 90° C. for 1 hour to dissolve the paramylon in the DMAc, whereby a first solution was prepared. At this time, the DMAc was heated using a water bath. The stirring was carried out at 150 rpm using a Teflon stirring blade. By introducing the DMAc into the flask and stirring, a suspension of the paramylon changed into a clear solution (first solution).

Subsequently, the heating of the DMAc was stopped and 13.98 mL (128.0 mmol) of pyridine was introduced. Subsequently, 17.3 mL of myristoyl chloride (2 equivalents (64.0 mmol) to a glucose unit of paramylon) was added dropwise at 80° C. After the dropwise addition was completed, the resultant product was heated to 90° C. using a water bath and stirred at 150 rpm for 1 hour. In this way, a reaction between paramylon and myristoyl chloride was proceeded, whereby a crude product including an intermediate product was obtained.

Subsequently, the heating was stopped to lower the temperature to 60° C., and then, 1 L of methanol was introduced. This deactivated the remaining myristoyl chloride and precipitated the intermediate product as a target. Subsequently, the supernatant liquid was removed and the precipitate was collected using a Kiriyama filtration (filter paper: No. 5A). The precipitate was dissolved in 400 mL of tetrahydrofuran, and then, re-precipitated using 1.6 L of a mixed solution of methanol and water (1:1). The precipitate was air-dried overnight, and then, dried at a reduced pressure of 200 Pa and at 60° C. for 4 hours to obtain an intermediate product with a structure in which a myristoyl group (C14 acyl group a) was introduced into paramylon.

### [Second Step]

Subsequently, the intermediate product obtained in the first step was dried at a reduced pressure of 200 Pa and at 60° C. for 4 hours. The intermediate product was placed in a 3 L flask, and nitrogen was supplied at a flow rate of 0.5 L/min. for 10 minutes to create a dry nitrogen atmosphere inside the flask. Subsequently, 250 ml of dehydrated toluene was introduced as a solvent B and stirred at 60° C. for 15 minutes, and then, 250 ml of dehydrated pyridine was introduced and stirred at 60° C. for 15 minutes. In this way, the intermediate product was dissolved in toluene, whereby a second solution was obtained. The heating described above was carried out using a water bath. The stirring was carried out at 150 rpm using a Teflon stirring blade.

Subsequently, the heating was stopped and 21.85 mL of octanoyl chloride (4 equivalents (128.0 mmol) to a glucose unit of paramylon) was added dropwise at 60° C. After the dropwise addition was completed, the resultant product was heated to 90° C. using a water bath, and after the temperature rise, stirring was carried out for 1 hour at 150 rpm using a Teflon stirring blade. In this way, a reaction between the intermediate product and octanoyl chloride was proceeded.

Subsequently, the heating was stopped to lower the temperature to 60° C., and then, 1 L of methanol was introduced. This deactivated the remaining octanoyl chloride and precipitated a desired paramylon derivative 1. Subsequently, the supernatant was removed by decantation, and the precipitate was dissolved in 500 mL of toluene. Subsequently, a re-precipitation process was carried out using 2.0 L of methanol. The precipitate was added to 500 mL of toluene and left to stand overnight. Subsequently, the resultant product was stirred at 8000 rpm for 5 minutes using a Homogenizing Disper Model 2.5 (manufactured by PRIMIX Corporation). Subsequently, a re-precipitation process was carried out using 2.0 L of methanol. By air-drying the precipitate, the paramylon derivative 1 having a structure with an octanoyl group (C8 acyl group b) further introduced into the intermediate product was obtained.

In the paramylon derivative 1, the total value T of the DS value of the acyl group a and the DS value of the acyl group b was 2.9. The ratio (Mₐ:M_{b}) of the amount of substance Mₐ of acyl group a to the amount of substance M_{b} of acyl group b was 1.5:1.5.

### [Pressure-Sensitive Adhesive Composition and Pressure-Sensitive Adhesive Sheet]

Firstly, the synthesized paramylon derivative 1 was dissolved in toluene to prepare a pressure-sensitive adhesive composition with a solid content concentration of 10 wt %. This pressure-sensitive adhesive composition was applied to a substrate sheet to produce a coating film. The substrate sheet used was Lumirror S-10 (polyester film, thickness: 25 μm) manufactured by Toray Industries, Inc. The pressure-sensitive adhesive composition was applied using an applicator (manufactured by TESTER SANGYO CO., LTD.). Subsequently, the coating film was dried at 100° C. for 6 minutes to obtain the pressure-sensitive adhesive sheet of Example 1. The pressure-sensitive adhesive sheet had a thickness of 50 μm.

### Example 2

A paramylon derivative 2 was synthesized by the same method as in Example 1, except that the added amounts of the myristoyl chloride and the octanoyl chloride were adjusted so that the ratio (Mₐ:M_{b}) of the amount of substance (Mₐ) of the acyl group a to the amount of substance (M_{b}) of the acyl group b would be 1.2:1.8. Furthermore, a pressure-sensitive adhesive composition was prepared by the same method as in Example 1, except that paramylon derivative 2 was used instead of the paramylon derivative 1, whereby the pressure-sensitive adhesive sheet of Example 2 was produced. The pressure-sensitive adhesive sheet had a thickness of 50 μm.

### Comparative Example 1

### [First Step]

Firstly, 5.19 g of paramylon (amount of substance of glucose unit: 32.0 mmol) was prepared as the β-1,3-glucan, and dried at a reduced pressure of 200 Pa and at 60° C. for 1 hour. Furthermore, 4.07 g of LiCl (3 equivalents (96.0 mmol) to a glucose unit of paramylon) was prepared and dried at 130° C. for 1 hour. Subsequently, the paramylon and the LiCl were placed in a 3 L flask, and nitrogen was supplied at a flow rate of 0.5 L/min. for 10 minutes to create a dry nitrogen atmosphere inside the flask. Subsequently, 500 mL of dehydrated DMAc was introduced as a solvent A, which was stirred at 90° C. for 1 hour to dissolve the paramylon in the DMAc, whereby a first solution was prepared. At this time, the DMAc was heated using a water bath. The stirring was carried out at 150 rpm using a Teflon stirring blade. By introducing the DMAc into the flask and stirring, the suspension of paramylon changed into a clear solution (first solution).

Subsequently, heating of the DMAc was stopped, and 13.98 mL (128.0 mmol) of pyridine was added. Subsequently, 10.92 mL of octanoyl chloride (2 equivalents (64.0 mmol) to a glucose unit of paramylon) was added dropwise at 80° C. After the dropwise addition was completed, the resultant product was heated to 90° C. using a water bath and stirred at 150 rpm for 1 hour. In this way, a reaction between paramylon and octanoyl chloride was proceeded, whereby a crude product including an intermediate product was obtained.

Subsequently, the heating was stopped to lower the temperature to 60° C., and then, 1 L of methanol was introduced. This deactivated the remaining octanoyl chloride and precipitated the intermediate product as a target. Subsequently, the supernatant liquid was removed and the precipitate was collected using a Kiriyama filtration (filter paper: 5A). The precipitate was dissolved in 150 mL of toluene, and then, re-precipitated using 2.5 L of methanol. The precipitate was air-dried overnight, and then, dried at a reduced pressure of 200 Pa and at 60° C. for 4 hours to obtain an intermediate product with a structure in which an octanoyl group (C8 acyl group) was introduced into paramylon.

### [Second Step]

Subsequently, the intermediate product obtained in the first step was dried at a reduced pressure of 200 Pa and at 60° C. for 4 hours. The intermediate product was placed in a 3 L flask, and nitrogen was supplied at a flow rate of 0.5 L/min. for 10 minutes to create a dry nitrogen atmosphere inside the flask. Subsequently, 250 ml of dehydrated toluene was added as a solvent B and stirred at 60° C. for 15 minutes, and then, 250 mL of dehydrated pyridine was introduced and stirred at 60° C. for 15 minutes. In this way, the intermediate product was dissolved in toluene, whereby a second solution was obtained. The heating described above was carried out using a water bath. The stirring was carried out at 150 rpm using a Teflon stirring blade.

Subsequently, the heating was stopped and 21.85 mL of octanoyl chloride (4 equivalents (128.0 mmol) to a glucose unit of paramylon) was added dropwise at 60° C. After the dropwise addition was completed, the resultant product was heated to 90° C. using a water bath, and after the temperature rise, stirring was carried out for 1 hour at 150 rpm using a Teflon stirring blade. In this way, a reaction between the intermediate product and the octanoyl chloride was proceeded.

Subsequently, the heating was stopped to lower the temperature to 60° C., and then, 1 L of methanol was introduced. This deactivated the remaining octanoyl chloride and precipitated a desired paramylon derivative 3. Subsequently, the supernatant was removed by decantation, and the precipitate was dissolved in 100 ml of toluene. Subsequently, a re-precipitation process was carried out using 1.0 L of methanol. The precipitate was added to 500 mL of toluene and left to stand overnight. Subsequently, the resultant product was stirred at 8000 rpm for 5 minutes using a Homogenizing Disper Model 2.5 (manufactured by PRIMIX Corporation). Subsequently, a re-precipitation process was carried out using 1.0 L of methanol. By air-drying the precipitate, the paramylon derivative 3 having a structure with an octanoyl group (C8 acyl group) further introduced into the intermediate product was obtained. The degree of substitution (DS value) of the acyl group in the paramylon derivative 3 was 2.9.

### [Pressure-Sensitive Adhesive Composition and Pressure-Sensitive Adhesive Sheet]

Firstly, the synthesized paramylon derivative 3 was dissolved in toluene to prepare a pressure-sensitive adhesive composition with a solid content concentration of 10 wt %. This pressure-sensitive adhesive composition was applied to a substrate sheet to produce a coating film. The substrate sheet used was Lumirror S-10 (polyester film, thickness: 25 μm) manufactured by Toray Industries, Inc. The pressure-sensitive adhesive composition was applied using an applicator (manufactured by TESTER SANGYO CO., LTD.). Subsequently, the coating film was dried at 100° C. for 6 minutes to obtain the pressure-sensitive adhesive sheet of Comparative Example 1. The pressure-sensitive adhesive sheet had a thickness of 50 μm.

### Comparative Example 2

### [First Step]

Firstly, 5.19 g of paramylon (amount of substance of glucose unit: 32.0 mmol) was prepared as the β-1,3-glucan, which was then dried at a reduced pressure of 200 Pa and at 60° C. for 1 hour. Further, 4.07 g of LiCl (3 equivalents (96.0 mmol) to a glucose unit of paramylon) was prepared and dried at 130° C. for 1 hour. Subsequently, the paramylon and the LiCl were placed in a 3 L flask, to which nitrogen was supplied at a flow rate of 0.5 L/min. for 10 minutes to create a dry nitrogen atmosphere inside the flask. Subsequently, 500 mL of dehydrated DMAc was introduced as a solvent A, which was stirred at 90° C. for 1 hour to dissolve the paramylon in the DMAc, whereby a first solution was prepared. At this time, the DMAc was heated using a water bath. The stirring was carried out at 150 rpm using a Teflon stirring blade. By introducing the DMAc into the flask and stirring, a suspension of the paramylon changed into a clear solution (first solution).

Subsequently, the heating of the DMAc was stopped and 13.98 mL (128.0 mmol) of pyridine was introduced. Subsequently, 17.30 ml of myristoyl chloride (2 equivalents (64.0 mmol) to a glucose unit of paramylon) was added dropwise at 80° C. After the dropwise addition was completed, the resultant product was heated to 90° C. using a water bath and stirred at 150 rpm for 1 hour. In this way, a reaction between paramylon and myristoyl chloride was proceeded, whereby a crude product including an intermediate product was obtained.

Subsequently, the heating was stopped to lower the temperature to 60° C., and then, 1 L of methanol was introduced. This deactivated the remaining myristoyl chloride and precipitated the intermediate product as a target. Subsequently, the supernatant liquid was removed and the precipitate was collected using a Kiriyama filtration (filter paper: No. 5A). The precipitate was dissolved in 100 ml of toluene, and then, re-precipitated using 500 mL of methanol. The precipitate was air-dried overnight, and then, dried at a reduced pressure of 200 Pa and at 60° C. for 4 hours to obtain an intermediate product with a structure in which a myristoyl group (C14 acyl group) was introduced into paramylon.

### [Second Step]

Subsequently, the intermediate product obtained in the first step was dried at a reduced pressure of 200 Pa and at 60° C. for 4 hours. The intermediate product was placed in a 3 L flask, and nitrogen was supplied at a flow rate of 0.5 L/min. for 10 minutes to create a dry nitrogen atmosphere inside the flask. Subsequently, 250 ml of dehydrated toluene was introduced as a solvent B and stirred at 60° C. for 15 minutes, and then, 250 ml of dehydrated pyridine was introduced and stirred at 60° C. for 15 minutes. In this way, the intermediate product was dissolved in toluene, whereby a second solution was obtained. The heating described above was carried out using a water bath. The stirring was carried out at 150 rpm using a Teflon stirring blade.

Subsequently, the heating was stopped and 34.60 mL of myristoyl chloride (4 equivalents (128.0 mmol) to a glucose unit of paramylon) was added dropwise at 60° C. After the dropwise addition was completed, the resultant product was heated to 90° C. using a water bath, and after the temperature rise, stirring was carried out for 1 hour at 150 rpm using a Teflon stirring blade. In this way, a reaction between the intermediate product and myristoyl chloride was proceeded.

Subsequently, the heating was stopped to lower the temperature to 60° C., and then, 1 L of methanol was introduced. This deactivated the remaining myristoyl chloride and precipitated a desired paramylon derivative 4. Subsequently, the supernatant was removed by decantation, and the precipitate was dissolved in 450 mL of toluene. Subsequently, a re-precipitation process was carried out using 2.0 L of methanol. The precipitate was added to 300 mL of toluene and left to stand overnight. Subsequently, the resultant product was stirred at 8000 rpm for 5 minutes using a Homogenizing Disper Model 2.5 (manufactured by PRIMIX Corporation). Subsequently, a re-precipitation process was carried out using 1.2 L of methanol. By air-drying the precipitate, the paramylon derivative 4 having a structure with a myristoyl group (C14 acyl group) further introduced into the intermediate product was obtained. The degree of substitution (DS value) of the acyl group in the paramylon derivative 4 was 2.9.

### [Pressure-Sensitive Adhesive Composition and Pressure-Sensitive Adhesive Sheet]

Firstly, the synthesized paramylon derivative 4 was dissolved in toluene to prepare a pressure-sensitive adhesive composition with a solid content concentration of 10 wt %. This pressure-sensitive adhesive composition was applied to a substrate sheet to produce a coating film. The substrate sheet used was Lumirror S-10 (polyester film, thickness: 25 μm) manufactured by Toray Industries, Inc. The pressure-sensitive adhesive composition was applied using an applicator (manufactured by TESTER SANGYO CO., LTD.). Subsequently, the coating film was dried at 100° C. for 6 minutes to obtain the pressure-sensitive adhesive sheet of Comparative Example 2. The pressure-sensitive adhesive sheet had a thickness of 50 μm.

### [Differential Scanning Calorimetry]

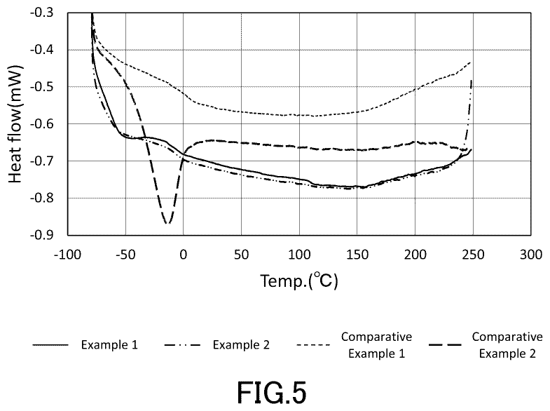

The β-1,3-glucan derivatives synthesized in Examples and Comparative Examples were subjected to differential scanning calorimetry by the above-mentioned method, thereby creating DSC curves. The differential scanning calorimetry was carried out by placing approximately 4 mg of β-1,3-glucan derivative in an aluminum pan, covering it with a lid, and setting it in a differential scanning calorimeter. The differential scanning calorimeter used was Q2000 manufactured by TA Instruments. The results are shown in FIG. 5. The presence or absence of an endothermic peak was confirmed from the DSC curve in FIG. 5.

As can be seen in FIG. 5, in a case where the β-1,3-glucan derivative of Comparative Example 2 was used, an endothermic peak with a peak top at −15° C. was observed in the DSC curve. Based on this result, the heat absorption in the range of −15° C.±30° C. was calculated from the DSC curve created for each of the Examples and Comparative Examples.

### [Glass Transition Temperature]

The glass transition temperatures of the pressure-sensitive adhesive sheets of Examples and Comparative Examples were determined using the method described above. The measurement samples for measuring the glass transition temperature were produced by laminating a plurality of pressure-sensitive adhesive sheets and punching out the resulting laminate in a disc shape. Dynamic viscoelasticity measurements were carried out using ARES-G2 manufactured by TA Instruments.

Each of the pressure-sensitive adhesive sheets of Examples and Comparative Examples is formed merely of the β-1,3-glucan derivative. Therefore, the glass transition temperature of the pressure-sensitive adhesive sheet measured can be considered to be the glass transition temperature of the corresponding β-1,3-glucan derivative.

### [Peeling Strength F]

For the pressure-sensitive adhesive sheets of Examples and Comparative Examples, the peeling strength F was measured by the above-described method. The peeling strength F was measured by using, as a tensile tester, a precision universal testing machine AUTOGRAPH AG-IS manufactured by SHIMADZU CORPORATION.

### [Tack Test]

A tack test was carried out on the pressure-sensitive adhesive sheets of Examples and Comparative Examples. The tack test was carried out by placing one finger on the surface of the pressure-sensitive adhesive sheet, keeping the finger thereon for one second, and then lifting the finger. If the pressure-sensitive adhesive sheet remains attached to the finger for one second or longer at the time of lifting the finger, it is determined as having tackiness (Yes). If the pressure-sensitive adhesive sheet comes off the finger in less than one second, it is determined as lacking tackiness (No).

TABLE 1

| | | | | | Comparative | Comparative |
|---|---|---|---|---|---|---|
| | | | Example 1 | Example 2 | Example 1 | Example 2 |
| Pressure- | β-1,3- | Type | Paramylon | Paramylon | Paramylon | Paramylon |
| sensitive | glucan | | derivative 1 | derivative 2 | derivative 3 | derivative 4 |
| adhesive | derivative | Degree of | 2.9 (*1) | 2.9 (*1) | 2.9 | 2.9 |
| composition | | substitution | | | | |
| | | (DS value) | | | | |
| | | Carbon number of | 14 | 14 | 8 | 14 |
| | | acyl group a | | | | |
| | | Carbon number of | 8 | 8 | — | — |
| | | acyl group b | | | | |
| | | Ratio (Mₐ:M_{b})(*2) | 1.5:1.5 | 1.2:1.8 | — | — |
| DSC curve | | Endothermic peak | Absent | Absent | Absent | Present |
| | | Heat absorption [J/g] | 1.37 | 0.46 | 0.64 | 22.5 |
| | | (−15° C. ± 30° C. range) | | | | |

| | | | | |
|---|---|---|---|---|
| Glass transition temperature Tg [° C.] | 9.7 | 12.6 | 15.6 | 17.2 |
| Peeling strength F [N/20 mm] | 0.86 | 0.72 | 0.42 | 2.07 |
| Tack | Yes | Yes | Yes | Yes |

(*1) Total value T of the DS value of the acyl group a and the DS value of the acyl group b
(*2)Ratio (Mₐ:M_{b}) of amount of substance Mₐ of acyl group a to amount of substance M_{b} of acyl group b

As can be seen from Table 1, the pressure-sensitive adhesive sheets of Examples, produced from the pressure-sensitive adhesive compositions including the β-1,3-glucan derivative having acyl groups a and b, had lower glass transition temperatures than the glass transition temperatures of Comparative Examples. This result indicates that the pressure-sensitive adhesive composition of this embodiment is suitable for producing a pressure-sensitive adhesive sheet having a low glass transition temperature. It is estimated that the pressure-sensitive adhesive sheets of Examples tend to show sufficient pressure-sensitive adhesiveness even in a low-temperature environment compared to the pressure-sensitive adhesive sheets of Comparative Examples.

### INDUSTRIAL APPLICABILITY

The pressure-sensitive adhesive composition of the present embodiment can be used for a pressure-sensitive adhesive tape.

1. A pressure-sensitive adhesive composition comprising a β-1,3-glucan derivative, wherein
the β-1,3-glucan derivative includes an acyl group a having a carbon number of 8 or more and an acyl group b having a carbon number different from the carbon number of the acyl group a, and the carbon number of the acyl group b is 8 or more.

2. The pressure-sensitive adhesive composition according to claim 1, wherein
the acyl group a is represented by the following formula (1): 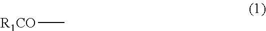
where R₁ is a hydrocarbon group having a carbon number of 10 to 15.

3. The pressure-sensitive adhesive composition according to claim 2, wherein
the R₁ is an alkyl group having a carbon number of 10 to 15.

4. The pressure-sensitive adhesive composition according to claim 1, wherein
the acyl group b is represented by the following formula (2): 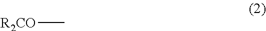
where R₂ is a hydrocarbon group having a carbon number of 7 to 9.

5. The pressure-sensitive adhesive composition according to claim 4, wherein
the R₂ is an alkyl group having a carbon number of 7 to 9.

6. The pressure-sensitive adhesive composition according to claim 1, wherein
a total value of a degree of substitution of the acyl group a and a degree of substitution of the acyl group b in the β-1,3-glucan derivative is 2.6 or more and less than 3.0.

7. The pressure-sensitive adhesive composition according to claim 1, wherein
a ratio (Mₐ:M_{b}) of an amount of substance Mₐ of the acyl group a to an amount of substance M_{b} of the acyl group b in the β-1,3-glucan derivative is in a range of 1:2 to 2:1.

8. The pressure-sensitive adhesive composition according to claim 1, wherein
the β-1,3-glucan derivative has a glass transition temperature of 15.0° C. or lower.

9. The pressure-sensitive adhesive composition according to claim 1, wherein
no endothermic peak is present in a DSC curve created by the following test:
the β-1,3-glucan derivative is placed in a differential scanning calorimeter, and the β-1,3-glucan derivative is heated from 25° C. to 250° C. at a temperature rise rate of 15° C./min. in a nitrogen atmosphere;
the β-1,3-glucan derivative is cooled from 250° C. to −80° C. at a temperature drop rate of 5° C./min.;
the β-1,3-glucan derivative is heated a second time from −80° C. to 250° C. at a temperature rise rate of 5° C./min.; and
a DSC curve is created from data obtained during the second time heating.

10. A pressure-sensitive adhesive sheet formed from the pressure-sensitive adhesive composition according to claim 1.

11. A laminate comprising:
the pressure-sensitive adhesive sheet according to claim 10, and
a substrate sheet.

12. A method for producing a β-1,3-glucan derivative, the method comprising:
introducing an acyl group a having a carbon number of 8 or more into β-1,3-glucan dissolved in a solvent A to synthesize an intermediate product with the acyl group a introduced, and
introducing an acyl group b into the intermediate product dissolved in a solvent B different from the solvent A to synthesize the β-1,3-glucan derivative, where the acyl group b has a carbon number different from the carbon number of the acyl group a and the carbon number of the acyl group b is 8 or more.

13. The method according to claim 12, wherein
the solvent A includes dimethylacetamide.

14. The method according to claim 12, wherein
the solvent B includes at least one selected from the group consisting of toluene, cyclohexane, and tetrahydrofuran.
